(19) United States
(12) Patent Application Publication
(10) Pub. No.: US 2010/0328234 A1
(43) Pub. Date: Dec. 30, 2010

(54) TOUCHPAD

(75) Inventor: CHUN-KU LU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/565,730

(22) Filed: Sep. 23, 2009

(30) Foreign Application Priority Data
Jun. 24, 2009 (CN) 200910303585.3

(51) Int. Cl. G06F 3/041

(52) U.S. Cl. 345/173

(57) ABSTRACT

A touchpad includes a touch board, a base, and a spring sandwiched between the touch board and the base. The touch board is mounted on an outmost side of the touchpad for touching thereon. The touch board includes a sleeve post. A base includes a pillar. A switch is secured on the base and located between the base and the touch board. A spring is sandwiched between the touch board and the base. One portion of the spring is retained on the sleeve post, and another portion of the spring is retained on the base. The touch board is slidable relative to the base between a first position and a second position. In the first position, the touch board and the switch is separated by the spring. In the second position, the touch board compresses the spring towards the base, and the switch is triggered by the touch board.

### BACKGROUND

1. Technical Field

The present disclosure relates to touchpads, and particularly to a touchpad having a switch function.

2. Description of Related Art

A touchpad is a pointing device consisting of a specialized surface that can translate the motion and position of a user finger touch to a relative position on-screen. They are a common feature of laptop computers and are used as a substitute for a computer mouse where desk space is scarce. They can also be found on personal digital assistants (PDAs) and some portable media players.

Commonly, electronic device manufacturers include a plurality of switches adjacent to the touchpad. For example, in a laptop computer, there are usually two keys adjacent to the touchpad, one of which works as a left mouse button, and the other of which works as a right mouse button. However, it is inconvenient for the users to simultaneously move their fingers on the touchpad and pressing the switches.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a touchpad.

FIG. 2 is similar to FIG. 1, but viewed from another aspect.

FIG. 3 is an assembly view of the touchpad of FIG. 1.

FIG. 4 is a section view taken along line IV-IV of FIG. 3.

FIG. 5 is another section view, taken alone line IV-IV of FIG. 3, when the touchpad is pressed.

### DETAILED DESCRIPTION

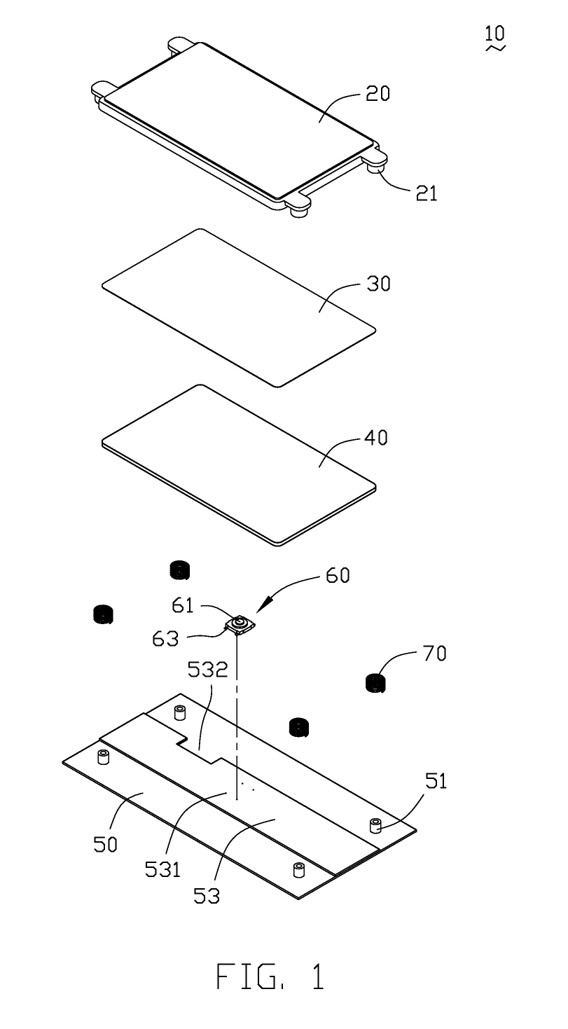

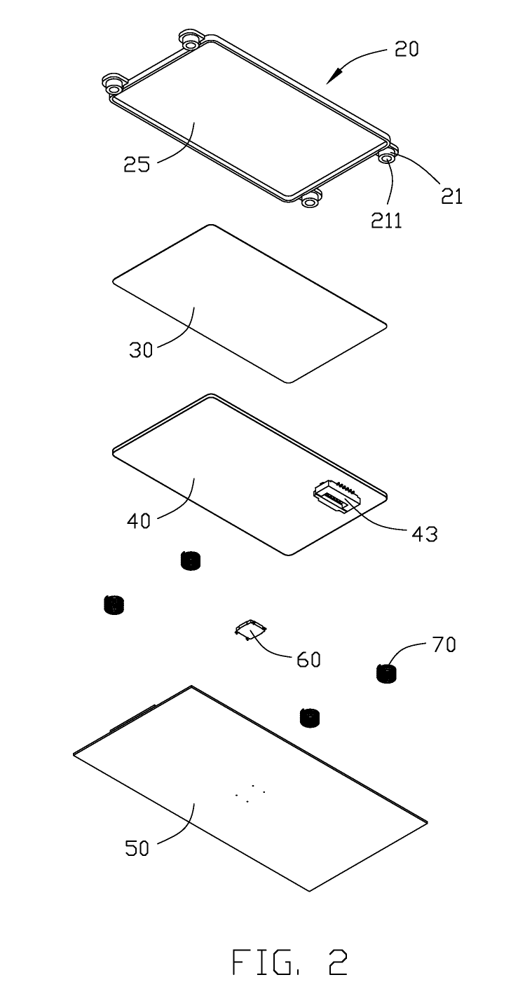

Referring to FIGS. 1 and 2, a touchpad 10, in accordance with an embodiment, includes a touch board 20, an insulation board 30, a sensing circuit board 40, a base 50, a switch 60, and a plurality of springs 70.

The touch board 20 is configured on the outmost side of the touchpad 10 for easy reach of user's fingers. Four corners of the touch board 20 extend downwardly to form four sleeve posts 21. Each sleeve post 21 is hollow, and defines a receiving hole 211. A cavity 25 is defined on a bottom side of the touch board 20.

The insulation board 30 is configured between the touch board 20 and the sensing circuit board 40 for insulating the touch board 20 from the sensing circuit board 40.

The sensing circuit board 40 has a grid (not shown) formed thereon. When the user's finger moves on the touch board 20, capacitance at different positions of the grid vary with the movement of the finger, and a corresponding movement signal is generated simultaneously. A port 43 is mounted on a bottom side of the sensing circuit board 40 for outputting the movement signal.

The base 50 is configured to be mounted on a laptop computer. Four corners of the base 50 extend upwardly to form four pillars 51 corresponding to the four sleeve posts 21 of the touch board 20. A portion of the base 50 is protruded to form a securing portion 53 thereon. Four through holes 531 are defined in the securing portion 53. A cutout 532 is defined in the securing portion 53 for receiving the port 43 of the sensing circuit board 40 therein.

An upper portion of the switch 60 has a movable button 61, and a bottom portion of the switch 60 has four pins 63 corresponding to the four through holes 531.

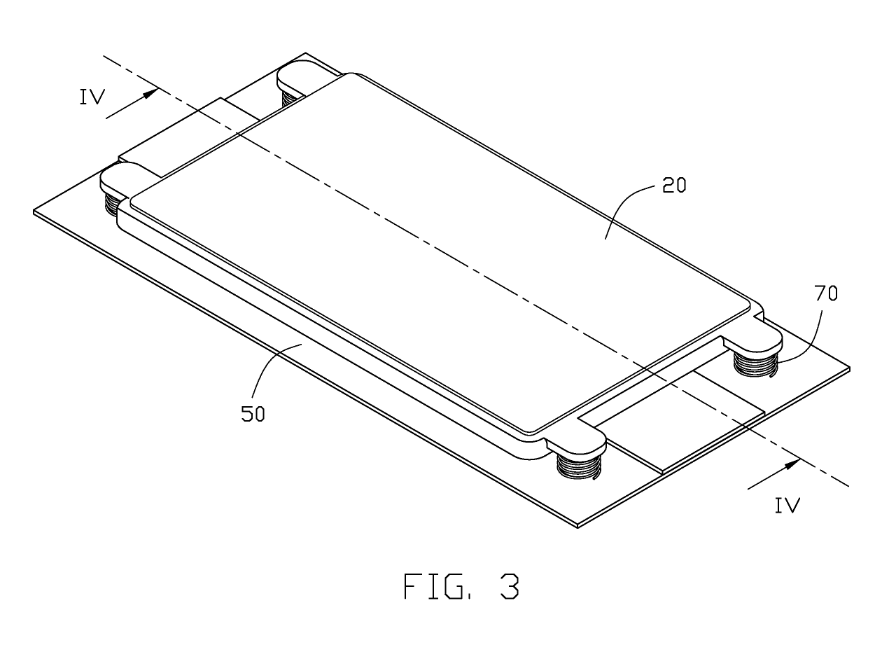

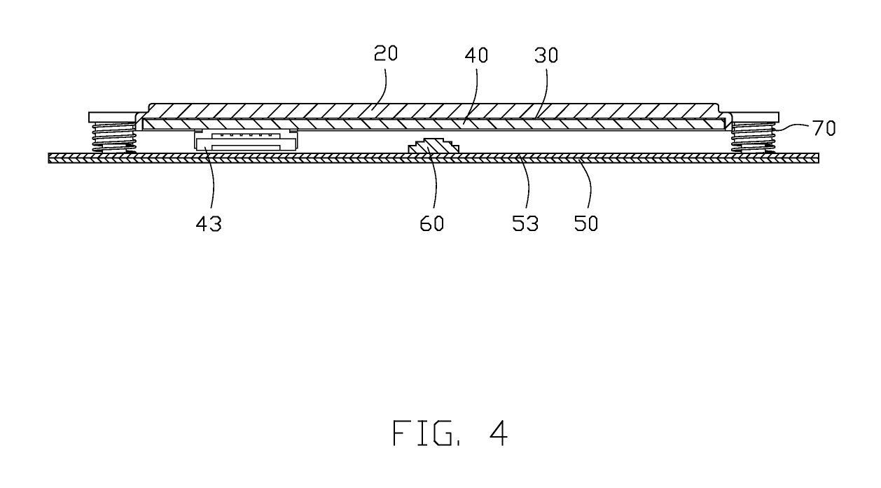

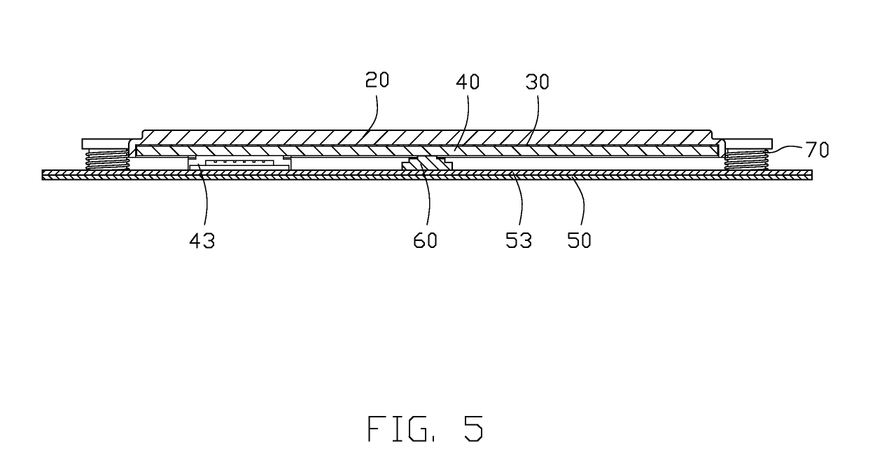

Referring to FIGS. 1 to 5, in assembly of the touchpad 10, four springs 70 are retained on the four pillars 51 of the base 50 with bottom ends of the springs 70 abutting the base 50. A top portion of each spring 70 is higher than a top end of corresponding pillar 51. The four pins 63 of the switch 60 extend through the four through holes 531 of the base 50 for transmitting a signal of the switch 60 when the button 61 is triggered.

The sensing circuit board 40 and the insulation board 30 are secured in the cavity 25 of the touch board 20. The sleeve posts 21 of the touch board 20 are aligned with the pillars 51 of the base 50. The top portions of the springs 70 are retained on the sleeve posts 21 of the touch board 20 with top ends of the springs 70 abutting the touch board 20. Thereby, the springs 70 are sandwiched between the touch board 20 and the base 50. At this position, the pillars 51 of the base 50 are inserted in the receiving holes 211 of the sleeve posts 21. The port 43 of the sensing circuit board 40 is received in the cutout 532 of the base 50. Thereby, the touchpad 10 is assembled.

In use, a movement of the user's finger on the touch board 20 is translated to a relative position on-screen. Simultaneously, the touch board 20 is capable of being pressed downwardly to active the button 61 of the switch 60, thereby triggering the switch 60 to generate some control signal, such as a left mouse button signal. When the touch board 20 is pressed downwardly, the pillars 51 of the base 50 slide in the receiving holes 211 of the touch board 20, and the springs 70 are elastically compressed. When the touch board 20 is released, the springs 70 rebound to drive the touch board 20 to move back, and the button 61 of the switch 60 is deactivated. In the embodiment, it is convenient for users to simultaneously move fingers on the touchpad 10 and press the switch 60.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A touchpad, comprising:
a touch board mounted on an outmost side of the touchpad for touching thereon, the touch board comprising a sleeve post;
a base comprising a pillar; a switch secured on the base and located between the base and the touch board; and
a spring sandwiched between the touch board and the base, one portion of the spring retained on the sleeve post, and another portion of the spring retained on the base;
wherein the touch board is slidable relative to the base between a first position and a second position; in the first position, the touch board and the switch is separated by the spring; in the second position, the touch board compresses the spring towards the base, and the switch is triggered by the touch board.

2. The touchpad of claim 1, wherein the sleeve post has a receiving hole in alignment with the pillar, and the pillar is inserted in the receiving hole at the second position.

3. The touchpad of claim 1, wherein a portion of the base is protruded to form a securing portion on which the switch is secured.

4. The touchpad of claim 3, wherein the securing portion defines a plurality of through holes, the switch comprises a plurality of pins extending through the though hole to transmit a signal of the switch outward when the switch is triggered.

5. The touchpad of claim 1, further comprising a sensing circuit board capable of sensing movement on the touch board, wherein the touch board defines a cavity in which the sensing circuit board is mounted; the sensing circuit board comprises a port, and the base defines a cutout capable of receiving the port when the touch board is located in the second position.

6. The touchpad of claim 5, wherein an insulation board is located between the touch board and the sensing circuit board.

7. A touchpad, comprising:
a base, a pillar formed on the base, a switch mounted on a first side of the base; and
a touch board mounted on the first side of the base and located above the switch; a sleeve post formed on the touchpad, the sleeve post defining a receiving hole in alignment with the pillar; the touch board being slidable on the base to trigger the switch with the pillar inserted in the receiving hole.

8. The touchpad of claim 7, wherein a spring is sandwiched between the touch board and the base, one portion of the spring is retained on the sleeve post, and another portion of the spring is retained on the pillar.

9. The touchpad of claim 7, wherein a portion of the base is protruded to form a securing portion on which the switch is secured.

10. The touchpad of claim 9, wherein the securing portion defines a plurality of through holes, the switch comprises a plurality of pins extending through the though hole to transmit a signal of the switch outward when the switch is triggered.

11. The touchpad of claim 7, further comprising a sensing circuit board capable of sensing movement on the touch board, wherein the touch board defines a cavity in which the sensing circuit board is mounted; the sensing circuit board comprises a port, and the base defines a cutout capable of receiving the port.

12. The touchpad of claim 11, wherein an insulation board is located between the touch board and the sensing circuit board.
